(19) United States
(12) Patent Application Publication
(10) Pub. No.: US 2025/0200577 A1
(43) Pub. Date: Jun. 19, 2025

(54) INFORMATION PROCESSING APPARATUS, INFORMATION PROCESSING SYSTEM, INFORMATION PROCESSING METHOD, AND NON-TRANSITORY COMPUTER-READABLE MEDIUM HAVING PROGRAM STORED THEREIN

(71) Applicant: NEC Corporation, Minato-ku, Tokyo (JP)

(72) Inventor: Risa TAGAWA, Tokyo (JP)

(73) Assignee: NEC Corporation, Minato-ku, Tokyo (JP)

(21) Appl. No.: 18/846,713

(22) PCT Filed: Mar. 28, 2022
(86) PCT No.: PCT/JP2022/015133

§ 371 Date: Sep. 13, 2024

(51) Int. Cl. G06Q 20/40; G06Q 20/20; G07F 17/32

(52) U.S. Cl. CPC G06Q 20/40145; G06Q 20/206; G07F 17/329

(57) ABSTRACT

An information processing apparatus (1) includes a storage unit (11) that stores subscription registration information and biometric information of a user who receives provision of a service associated to the subscription registration information in association with each other, an acquisition unit (12) that acquires biometric information of a user from a terminal installed in a store, an authentication processing unit (13) that executes authentication processing of the acquired biometric information and the biometric information stored in the storage unit (11), and a processing unit (14) that outputs subscription registration information associated with biometric information of a user when the user is authenticated as a registrant by authentication processing of the authentication processing unit (13).

### TECHNICAL FIELD

The present disclosure relates to an information processing apparatus, an information processing system, an information processing method, and a non-transitory computer-readable medium storing a program.

### BACKGROUND ART

Patent Literature 1 discloses a service provision system applied to a subscription service that provides a user with a necessary article at a destination. In the system of Patent Literature 1, at a time of using the subscription service, biometric information of a user is registered and stored in association with a unique user ID given to the user. When the subscription service is used, a terminal apparatus of a user is requested to transmit biometric authentication, and when it is authenticated in authentication processing based on the acquired biometric authentication, a service provision apparatus is requested to provide an article to be used by the user.

### CITATION LIST

### Patent Literature

Patent Literature 1: International Patent Publication No. WO2021/186555

### SUMMARY OF INVENTION

### Technical Problem

In Patent Literature 1, since biometric authentication is transmitted from a terminal apparatus of a user, there is a possibility that an article is illegally acquired by spoofing (impersonation).

In view of the above-described problem, an object of the present disclosure is to provide an information processing apparatus, an information processing system, an information processing method, and a program that are capable of suppressing illegal acquisition of an article or the like due to impersonation.

### Solution to Problem

An information processing apparatus according to one aspect of the present disclosure includes: a storage means for storing subscription registration information and biometric information of a user who receives provision of a service associated to the subscription registration information in association with each other; an acquisition means for acquiring biometric information of a user from a terminal installed in a store; an authentication processing means for executing authentication processing of the acquired biometric information and the biometric information stored in the storage means; and a processing means for outputting subscription registration information associated with biometric information of a user when the user is authenticated as a registrant by authentication processing of the authentication processing means.

An information processing system according to one aspect of the present disclosure includes: a terminal installed in a store; and an information processing apparatus, wherein the information processing apparatus includes a storage means for storing subscription registration information and biometric information of a user who receives provision of a service associated to the subscription registration information in association with each other, an acquisition means for acquiring biometric information of a user from the terminal, an authentication processing means for executing authentication processing of the acquired biometric information and the biometric information stored in the storage means, and a processing means for outputting subscription registration information associated with biometric information of a user when the user is authenticated as a registrant by authentication processing of the authentication processing means.

An information processing method according to one aspect of the present disclosure includes, by a computer: storing subscription registration information and biometric information of a user who receives provision of a service associated to the subscription registration information in association with each other; acquiring biometric information of a user from a terminal installed in a store; executing authentication processing of the acquired biometric information and the stored biometric information; and outputting subscription registration information associated with biometric information of a user when the user is authenticated as a registrant by the authentication processing.

A program according to one aspect of the present disclosure causes a computer to execute: processing of storing subscription registration information and biometric information of a user who receives provision of a service associated to the subscription registration information in association with each other; processing of acquiring biometric information of a user from a terminal installed in a store; processing of executing authentication processing of the acquired biometric information and the stored biometric information; and processing of outputting subscription registration information associated with biometric information of a user when the user is authenticated as a registrant by the authentication processing.

### Advantageous Effect of Invention

According to the present disclosure, illegal acquisition of an article or the like by impersonation can be suppressed.

### BRIEF DESCRIPTION OF DRAWINGS

FIG. 1 is a block diagram illustrating a configuration of an information processing apparatus according to a first example embodiment;

FIG. 2 is a flowchart describing a flow of an information processing method according to the first example embodiment;

FIG. 3 is a block diagram illustrating an overall configuration of an information processing system according to a second example embodiment;

FIG. 4 is a block diagram illustrating a configuration of a user terminal in FIG. 3;

FIG. 5 is a block diagram illustrating a configuration of a store terminal in FIG. 3;

FIG. 6 is a block diagram illustrating a configuration of an authentication apparatus in FIG. 3;

FIG. 7 is a flowchart illustrating a flow of face feature information registration processing performed by the authentication apparatus according to the second example embodiment;

FIG. 8 is a block diagram illustrating a configuration of a server in FIG. 3;

FIG. 9 is a sequence diagram illustrating a flow of provision of a service associated to subscription registration information according to the second example embodiment;

FIG. 10 is a flowchart illustrating a flow of face authentication processing performed by the authentication apparatus according to the second example embodiment;

FIG. 11 is a diagram describing a flow at a time when a user receives provision of a service associated to subscription registration information; and

FIG. 12 is a diagram illustrating one example of a screen displayed on the store terminal.

### EXAMPLE EMBODIMENT

Hereinafter, example embodiments of the present disclosure will be described in detail with reference to the drawings. In each of the drawings, the same or corresponding elements are denoted by the same reference signs, and redundant descriptions are omitted as necessary for clarity of description.

### First Example Embodiment

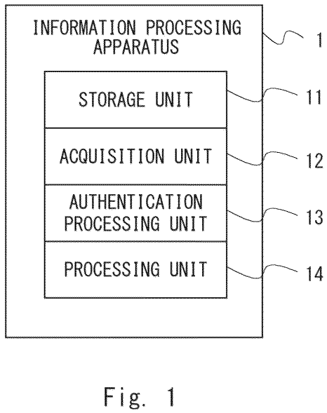

FIG. 1 is a block diagram illustrating a configuration of an information processing apparatus 1 according to a first example embodiment. The information processing apparatus 1 is an apparatus being capable of suppressing illegal acquisition of an article or the like by impersonation when a user who has performed subscription registration receives a service associated to the subscription registration information in a store. The information processing apparatus 1 manages the subscription registration information of a user in a database.

A subscription is a method in which a fee is periodically paid for a right that can be used for a predetermined period of time instead of paying a purchase price of a product or a fee for use of a service. A user is performed subscription registration by paying a fixed fee. A registered user can receive provision of a service associated to subscription registration information for a predetermined period of time.

For example, a plurality of subscription plans having different fixed amounts (e.g., a monthly amount of 3000 yen plan, a monthly amount of 5000 yen plan, a monthly amount of 8000 yen plan, and the like) are prepared, and a user selects one of the plans and makes a contract. A user is performed subscription registration with the selected plan. Associated to the subscription registration information, a user who has performed the subscription registration can use a sports club, a fitness club, or a share office as much as he/she likes without worrying about the fee for a predetermined period of time, or receive provision of food and drink in a restaurant.

For example, in a restaurant, an inexpensive plan in which only provision of drink can be received, or an expensive plan in which provision of all food and drink provided in the restaurant can be received may be set. Further, in a sports club, an inexpensive plan in which a usable area or time is restricted, or an expensive plan in which all areas can be used in an unlimited time may be set.

The subscription registration information includes restriction information of a product, a period, a place, and the like to be provided.

For example, before visiting a store, a user can perform subscription registration by transmitting a predetermined matter from a web page for subscription registration by using a user terminal possessed by the user. Note that, when visiting a store, a user can perform subscription registration by a store terminal installed in the store.

Each user who has performed the subscription registration is given a user ID such as a member number as unique identification information. In addition to the registration information of the subscription, various types of attribute information including a registration history of a subscription of a user, a usage history of a service associated to the subscription registration information, a payment amount, and the like may be associated with the individual user ID. Further, the attribute information may include information (privilege information such as a coupon or a sales promotion content) (hereinafter, referred to as notification information) desired to be notified to a user related to the subscription registration information. Hereinafter, the subscription registration information and various types of attribute information are collectively referred to as user information.

In the related art, a medium (a member card or the like) in which registration information or the like is stored is issued at a store where subscription registration is performed. A user presents the member card at a store and receives a service. In this case, there is a risk that a person who has acquired a member card of another person illegally receives a service due to spoofing. Further, a staff of a store needs to manually confirm the member card presented by a user each time, and it takes effort and time to deal with.

In view of such circumstances, the present inventors have devised the following configuration. The information processing apparatus 1 according to the first example embodiment is an apparatus being capable of receiving provision of a service associated to registration information even when a user who has performed subscription registration does not possess the member card. The information processing apparatus 1 performs biometric authentication using biometric information, and performs personal identification of a user.

A user registers his/her biometric information (a face, a fingerprint, and the like) in advance at a time of subscription registration. As biometric authentication using biometric information, various techniques using a photographed image can be applied. As the biometric information, data (feature amount) based on a physical characteristic being unique to an individual such as a face, a fingerprint, a voice print, a vein, a retina, and an iris of a pupil can be used.

For example, a user can photograph his/her own face image with a camera provided in his/her own user terminal, and transmit the generated face image to the information processing apparatus 1 or an authentication apparatus as biometric information (for registration). Note that, a user's face image may be photographed by a terminal installed in a store and transmitted to the information processing apparatus 1 or the authentication apparatus. Further, a user can register, in advance, payment information such as a valid credit card or electronic money that can be used for payment at a time of subscription registration. The payment information is also included in the user information described above.

The information processing apparatus 1 is connected to a predetermined terminal by a network (not illustrated) or a predetermined wireless communication. The network may be wired or wireless, and a type of communication protocol does not matter. The terminal transmits biometric information (for authentication) of a user to the information processing apparatus 1. Further, the terminal performs processing based on an output from the information processing apparatus 1 according to an authentication result. The terminal includes a store terminal installed in a store, a user terminal possessed by a user, and the like.

As illustrated in FIG. 1, the information processing apparatus 1 includes a storage unit 11, an acquisition unit 12, an authentication processing unit 13, and a processing unit 14. The storage unit 11 stores subscription registration and biometric information (for registration) of a user who receives provision of a service associated to the subscription registration in association with each other. The storage unit 11 can store the biometric information (for registration) of a user and the subscription registration in a built-in or external storage apparatus in association with each other.

The acquisition unit 12 acquires biometric information (for authentication) of a user from a store terminal installed in a store. As one example, the biometric information may be a face image, and authentication of personal identification may be face authentication. For example, the store terminal includes a capturing apparatus such as a camera, and can generate a face image by photographing. The biometric information of a user may be automatically generated by the store terminal, or may be generated in response to an input from a user or a staff. Such a store terminal may be fixed to a necessary place in a store, or may be carried by a staff. A portable store terminal may be, for example, a mobile phone, a smartphone, a tablet, or the like.

The authentication processing unit 13 executes authentication processing of the acquired biometric information and the biometric information (for registration) stored in the storage unit 11. Note that, the store terminal may transmit the acquired biometric information to the authentication apparatus in which the biometric information (for registration) of a user is registered in advance, and an authentication result may be transmitted to the information processing apparatus 1. The information processing apparatus 1 may receive the authentication result and perform processing in response to the received authentication result.

When the authentication processing of the authentication processing unit 13 authenticates that a user is a registrant, the processing unit 14 outputs the subscription registration information associated with the biometric information of the user. A staff of a store can provide a service associated to the subscription registration information.

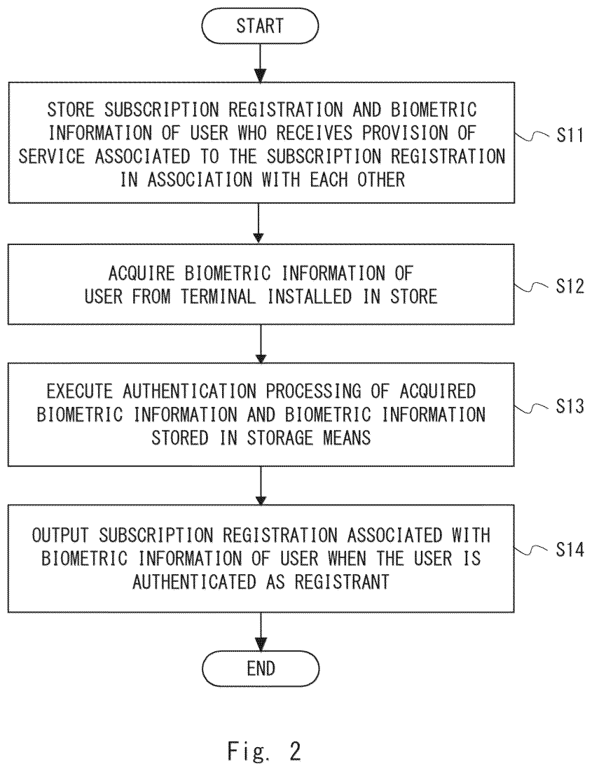

FIG. 2 is a flowchart illustrating a flow of an information processing method according to the first example embodiment. First, subscription registration and biometric information of a user who receives provision of a service associated to the subscription registration are stored in association with each other (S11). Next, the biometric information of a user is acquired from the store terminal installed in a store (S12).

Then, authentication processing of the acquired biometric information and the biometric information stored in the storage unit 11 is executed (S13). When the authentication processing of the authentication processing unit 13 authenticates that a user is a registrant, the subscription registration associated with the biometric information of the user is output (S14).

As described above, the information processing apparatus 1 according to the first example embodiment can receive provision of a service associated to subscription registration even when a user does not possess a member card, by performing personal identification by biometric authentication using the biometric information of the user who has been performed subscription registration at a store. As a result, it becomes possible to prevent spoofing due to illegal acquisition of the member card.

Note that, the information processing apparatus 1 includes a processor, a memory, and a storage apparatus as a not-illustrated configuration. The storage apparatus stores a program causing a computer to execute each piece of processing of the information processing method according to the first example embodiment. The processor reads a program from the storage apparatus into the memory, and executes the program. As a result, the processor achieves each function of the storage unit 11, the acquisition unit 12, the authentication processing unit 13, and the processing unit 14.

Alternatively, each component of the information processing apparatus 1 may be achieved by dedicated hardware. Further, some or all of each component of each apparatus may be achieved by circuitry in general-purpose or special-purpose, a processor, or the like, or a combination thereof. These may be configured by a single chip, or may be configured by a plurality of chips connected via a bus to each other. Some or all of each component of each apparatus may be achieved by a combination of the above-described circuitry or the like and a program. Further, as the processor, a central processing unit (CPU), a graphics processing unit (GPU), a field-programmable gate array (FPGA), a quantum processor (a quantum computer control chip), and the like can be used.

Further, when some or all of each component of the information processing apparatus 1 are achieved by a plurality of information processing apparatuses, pieces of circuitry, and the like, the plurality of information processing apparatuses, pieces of circuitry, and the like may be centrally arranged, or may be distributedly arranged. For example, the information processing apparatus, the circuitry, and the like may be achieved as a form in which each of the information processing apparatus, the circuitry, and the like is connected via a communication network, such as a client server system, a cloud computing system, and the like. Further, a function of the information processing apparatus 1 may be provided in a software as a service (Saas) format.

### Second Example Embodiment

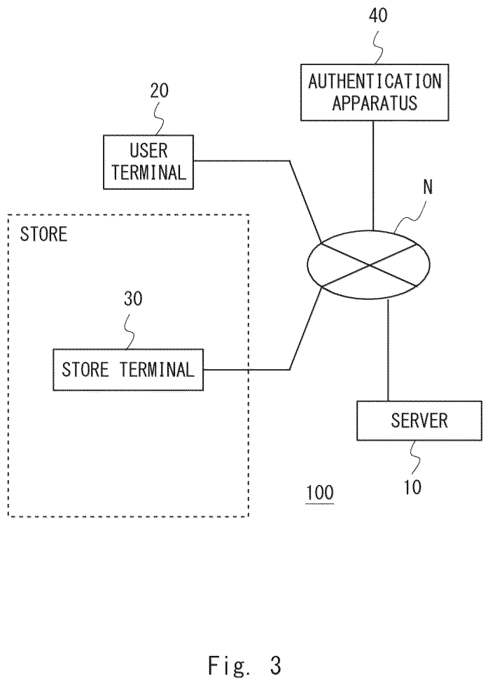

A second example embodiment is a specific example of the first example embodiment described above. FIG. 3 is a block diagram illustrating an overall configuration of an information processing system 100 according to the second example embodiment. The information processing system 100 includes a server 10, a user terminal 20, a store terminal 30, and an authentication apparatus 40. The server 10, the store terminal 30, the user terminal 20, and the authentication apparatus 40 are connected to one another via a network N. Herein, the network N is a wired or wireless communication line, for example, the Internet.

The information processing system 100 is a system in which a user registered in a subscription plan provided by a store performs biometric authentication, and thereby the user can receive provision of a service associated to the subscription registration information. Herein, an example of registering with a subscription plan and registering his/her own biometric information (for registration) by using the user terminal 20 possessed by a user will be described.

The biometric information used for biometric authentication is information used for authentication of personal identification (personal authentication, personal specifying processing, and the like), and is information for uniquely specifying (identifying) a person in question. In the second example embodiment, it is described as face authentication being one example of biometric authentication, and that biometric information is as a face image. In other words, a face image (for registration) is identification information for specifying a user who performs subscription registration.

Note that, as the biometric authentication and the biometric information, other techniques using a photographed image of a person can be applied. For example, as the biometric information, data (feature amount) calculated from a physical characteristic being unique to an individual such as a fingerprint, a voice print, a vein, a retina, an iris of a pupil, and a palm pattern may be used.

### User Terminal 20

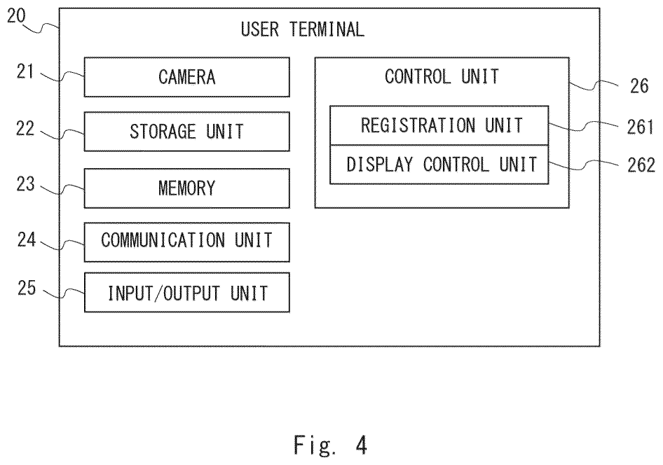

The user terminal 20 is an information terminal that a user possesses, operates, and performs transmission and reception of data to and from the server 10 via the network N by wireless communication. The user terminal 20 is a mobile phone, a smartphone, a tablet terminal, or the like. FIG. 4 is a block diagram illustrating a configuration of the user terminal 20 in FIG. 3.

The user terminal 20 includes a camera 21, a storage unit 22, a memory 23, a communication unit 24, an input/output unit 25, and a control unit 26. The camera 21 is a photographing apparatus that performs photographing according to control of the control unit 26. The storage unit 22 is one example of a storage apparatus including a non-volatile memory such as a flash memory or a solid state drive (SSD). The storage unit 22 stores a program in which processing including registration processing of information or a face image necessary for subscription registration, display processing of various types of information, and the like is implemented.

The memory 23 is a volatile storage apparatus such as a random access memory (RAM), and is a storage region for temporarily storing information when the control unit 26 operates. The communication unit 24 is a communication interface with the network N. Further, the communication unit 24 may establish connection for short-range wireless communication with the store terminal 30, and perform communication. Herein, various standards such as Bluetooth (registered trademark), Bluetooth low energy (BLE), and an ultra wide band (UWB) can be applied to the short-range wireless communication.

The input/output unit 25 is, for example, a touch panel including a display apparatus and an input apparatus. The control unit 26 is a processor that controls hardware included in the user terminal 20. The control unit 26 reads a program from the storage unit 22 into the memory 23, and executes the program. As a result, the control unit 26 achieves functions of a registration unit 261 and a display control unit 262.

The registration unit 261 performs registration processing of information and a face image input by a user necessary for subscription registration. Specifically, the registration unit 261 accepts information and a face image input by a user. The registration unit 261 transmits a registration request of the accepted information and face image to the server 10 via the network N. Further, a user can register his/her own payment information in advance. The payment information is credit card information, electronic money payment information, two-dimensional code (QR code (registered trademark)) payment information, and the like, but these are merely examples.

As will be described later, face feature information of the user is registered in a face information DB 41 of the authentication apparatus 40, and user information including the subscription registration information and the payment information is registered in an information DB 112 of the server 10. The subscription registration information and the face feature information are associated with each other by a user ID issued when the user information is registered.

The registration unit 261 may receive the user ID from the server 10 via the network N, and register the received user ID in the storage unit 22. The display control unit 262 can display notification information related to the subscription registration information transmitted from the server 10 via the network N at a time of successful authentication. Such information may be a sales promotion content used for sales promotion of a store. The sales promotion content is, for example, a bingo game using a digital bingo card in which a plurality of bingo frames are arranged.

The server 10 may provide the user terminal 20 with a digital bingo card in which a plurality of bingo frames are arranged in a matrix shape. The display control unit 262 displays a digital bingo card on a screen of the input/output unit 25. For the bingo frame, for example, a frequency of opening the bingo frame is decided based on the subscription registration information. As one example, the higher an amount of a subscription plan, the more the bingo frame is opened, and thereby a probability that the bingo is completed can be increased. Further, the bingo frame may be opened more as a payment amount by face authentication other than the subscription plan is higher. As another example, the frequency of opening the bingo frame may be decided according to a subscription registration history of a user, a usage history of a service, a visit history, or the like.

When the bingo is completed, the server 10 can generate privilege information such as a coupon usable in a store for which subscription registration is performed or a nearby facility, and transmit the generated privilege information to the user terminal 20. The privilege information includes a content such that a discount or a present can be received at a store. Note that, the server 10 may output the above-described sales promotion content to the store terminal 30.

Further, the sales promotion content may be privilege information used for sales promotion of a store being a destination of remitting a customer different from the store. For example, when face authentication is used in a store A, the server 10 can transmit, to the server 10, privilege information usable in a store B being different from the store A. Further, when face authentication is used in the store B, the server 10 can transmit, to the server 10, the privilege information usable in the store A. As described above, by mutually remitting a customer among a plurality of stores, it is possible to guide a visitor to each store, and it is possible to increase the number of visitors.

### Store Terminal 30

The store terminal 30 is installed in a store, and operated by a user or a staff. The store terminal 30 performs transmission and reception of data to and from the server 10 via the network N. The store terminal 30 is, for example, a POS terminal including an authentication terminal and a payment terminal. The store terminal 30 is used for payment of a purchase price of a product not subject to a subscription plan, a usage fee of a service, and the like, in addition to payment of a fixed fee for the plan. The store terminal 30 specifies the subscription registration information by using a result of biometric authentication of a user. A staff of a store provides a user with a service associated to the specified subscription registration.

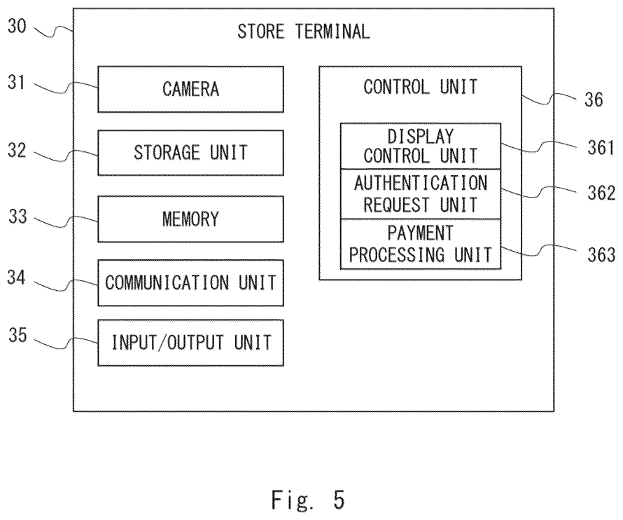

FIG. 5 is a block diagram illustrating a schematic configuration of the store terminal 30 in FIG. 3. As illustrated in FIG. 5, the store terminal 30 includes a camera 31, a storage unit 32, a memory 33, a communication unit 34, an input/output unit 35, and a control unit 36. The camera 31 is a photographing apparatus that performs photographing according to control of the control unit 36. The storage unit 32 is one example of a storage apparatus including a non-volatile memory such as a flash memory or a solid state drive (SSD). The storage unit 32 stores a program in which each piece of processing including authentication request processing for executing payment processing to be described later is implemented.

The memory 33 is a volatile storage apparatus such as a random access memory (RAM), and is a storage region for temporarily storing information when the control unit 36 operates. The communication unit 34 is a communication interface with the network N. The input/output unit 35 is, for example, a touch panel including a display apparatus (display unit) of a screen or the like, and an input apparatus (input unit).

The control unit 36 is a processor that controls hardware included in the store terminal 30. The control unit 36 reads a program from the storage unit 32 into the memory 33, and executes the program. As a result, the control unit 36 achieves functions of a display control unit 361, an authentication request unit 362, and a payment processing unit 363.

The display control unit 361 causes the input/output unit 35 to display a screen generated by execution of the program. The display control unit 361 may display a message prompting face photographing for face authentication.

The authentication request unit 362 extracts a face region of a person as a face image from an image photographing a user by the camera 31, and transmits an authentication request to the server 10. Note that, the authentication request unit 362 may transmit an authentication request including a face image to the authentication apparatus 40.

The display control unit 361 causes the input/output unit 35 to display a result of authentication processing. When the authentication is successful, the subscription registration information is transmitted from the server 10 to the store terminal 30. The display control unit 361 displays the subscription registration information related to the authenticated user transmitted from the server 10. A staff of a store can confirm the subscription registration information displayed on the screen, and perform provision of a product associated to the information, and the like.

Further, when the notification information related to the subscription registration information is received from the server 10 when the authentication is successful, the display control unit 361 can cause the display control unit 361 to display the information.

The payment processing unit 363 executes payment processing related to subscription registration, or payment processing for purchasing another product and the like. The payment may be a cash payment, or may be a non-cash payment such as a credit card, a debit card, or electronic money. In order to accept payment using cash, a card, or the like, the payment terminal includes a cash input port, an automatic change machine, a card reader, and the like.

When payment information such as a valid credit card and electronic money that can be used for payment are registered in advance at a time of subscription registration, the payment processing unit 363 can automatically perform the payment processing by using the registered payment information in response to success of face authentication.

### Authentication Apparatus 40

The authentication apparatus 40 is an information processing apparatus that manages face feature information of a user and performs face authentication. Further, in response to an authentication request received from outside, the authentication apparatus 40 performs collation of a face image (for authentication) included in the request with the face feature information of a user to be managed, and replies a collation result (authentication result) to a request source.

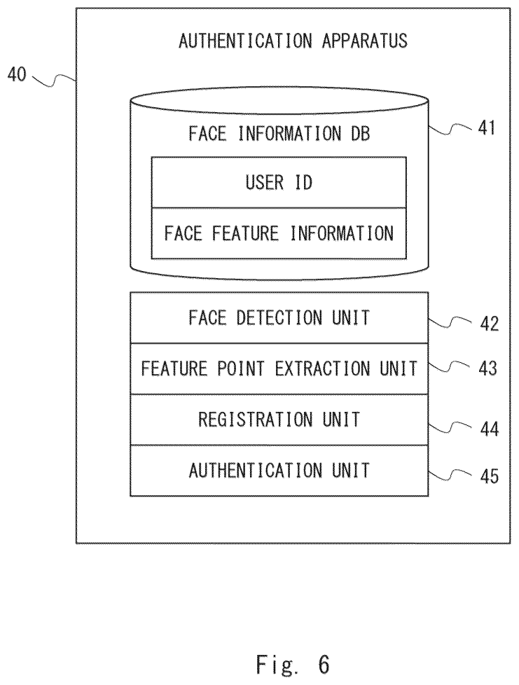

FIG. 6 is a block diagram illustrating a configuration of the authentication apparatus 40 in FIG. 3. The authentication apparatus 40 includes the face information database (DB) 41, a face detection unit 42, a feature point extraction unit 43, a registration unit 44, and an authentication unit 45. The face information DB 41 stores face feature information being a set of feature points extracted from a face image (for registration). The face information DB 41 stores a user ID described later and face feature information in association with each other. Note that, the authentication apparatus 40 may delete the face feature information in the face feature DB 41 in response to a request from a user or the like associated to the face feature information. Alternatively, the authentication apparatus 40 may delete the face feature information after a certain period of time has elapsed from registration.

The face detection unit 42 detects a face region included in a face image (for registration) for registering face feature information, and outputs the detected face region to the feature point extraction unit 43. The feature point extraction unit 43 extracts a feature point from the face region of the face image (for registration) received from the user terminal 20 or the like, and outputs the face feature information to the registration unit 44. The registration unit 44 newly issues a user ID when registering the face feature information. The registration unit 44 registers the issued user ID and the face feature information extracted from the face image (for registration) in association with each other in the face information DB 41.

Further, the face detection unit 42 detects a face region included in a face image (for authentication) used in authentication processing, and outputs the detected face region to the feature point extraction unit 43. Further, the feature point extraction unit 43 extracts a feature point included in the face image (for authentication) received from the server 10 or the like, and outputs the face feature information to the authentication unit 45.

The authentication unit 45 performs face authentication using the face feature information. Specifically, the authentication unit 45 performs collation of the face feature information extracted from the face image (for authentication) with the face feature information in the face information DB 41. The authentication unit 45 replies presence or absence of matching of the face feature information to a request source as a face authentication result. The presence or absence of the matching of the face feature information corresponds to success or failure of the authentication. Note that, matching the face feature information refers to a case where a degree of coincidence is equal to or greater than a threshold value. Further, when the face authentication is successful, the face authentication result includes the specified user ID.

For example, when an authentication request is transmitted from the server 10, the authentication unit 45 performs face authentication on a face image included in the authentication request, and replies an authentication result to the server 10. When the authentication is successful, an authentication processing unit 13 of the server 10 specifies the subscription registration information associated with the collated face feature information.

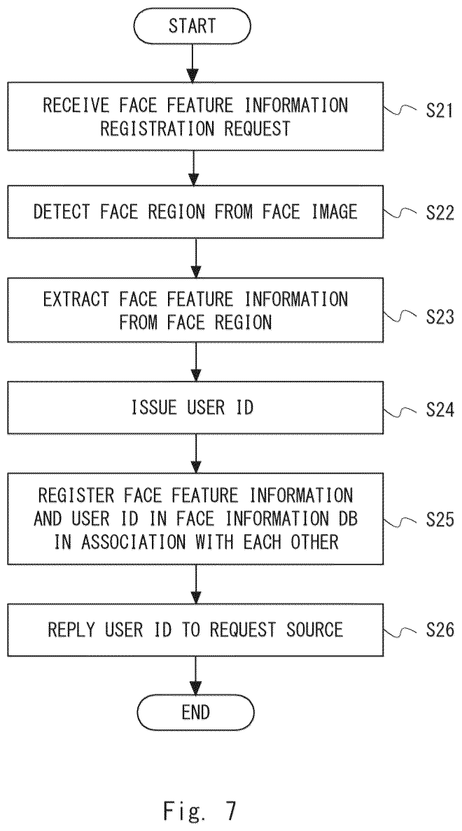

FIG. 7 is a flowchart illustrating a flow of face feature information registration processing performed by the authentication apparatus 40 according to the second example embodiment. First, the authentication apparatus 40 receives a registration request of a face image transmitted from the user terminal 20 (S21). In this example, the authentication apparatus 40 receives the registration request of the face image transmitted from the user terminal 20 via the server 10. Next, the face detection unit 42 detects a face region from the face image included in the face feature information registration request (S22). Then, the feature point extraction unit 43 extracts a feature point (face feature information) from the face region detected in step S22 (S23). Then, the registration unit 44 issues a user ID (S24), and registers the issued user ID in association with the extracted face feature information in the face information DB 41 (S25).

Thereafter, the registration unit 44 replies the issued user ID to a request source (e.g., the server 10) (S26). Note that, the authentication apparatus 40 may perform face feature information registration processing in response to a face feature information registration request received from any information registration terminal. For example, the information registration terminal may be the user terminal 20 or the store terminal 30.

### Server 10

The server 10 is one example of the information processing apparatus 1. The server 10 is an information processing apparatus that performs biometric information registration processing, subscription registration information specifying processing, sales promotion content generation processing, and the like (an information processing method according to the second example embodiment). Note that, the server 10 may be configured by a plurality of servers, and each functional block may be achieved by a plurality of computers.

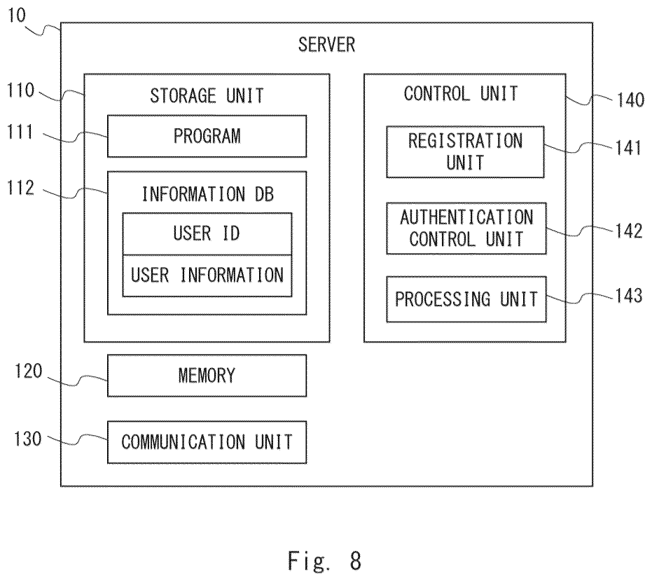

FIG. 8 is a block diagram illustrating a configuration of the server 10 in FIG. 3. The server 10 includes a storage unit 110, a memory 120, a communication unit 130, and a control unit 140. The storage unit 110 is one example of a storage apparatus such as a hard disk and a flash memory. The storage unit 110 stores a program 111 and the information DB 112. The program 111 is a computer program in which a part of registration processing of a face image and information necessary for subscription registration, face authentication processing, payment processing, and the like is implemented.

The information DB 112 is a database that manages user information of a user who has been performed subscription registration. The information DB 112 manages the user ID and the user information in association with each other. In other words, in the second example embodiment, the biometric information and the user information are associated with the user ID, and are managed by each of the face information DB 41 of the authentication apparatus 40 and the information DB 112 of the server 10. The biometric information is a face image herein. Further, as described above, the user information includes subscription registration information, various types of attribute information such as privilege information, and payment information. The payment information is credit card information, electronic payment information, or the like used when the payment processing is performed in response to success of biometric authentication.

The memory 120 is a volatile storage apparatus such as a random access memory (RAM), and is a storage region for temporarily storing information when the control unit 140 operates. The communication unit 130 is a communication interface with the network N.

The control unit 140 is a processor that controls each configuration of the server 10. The control unit 140 reads the program 111 from the storage unit 110 into the memory 120, and executes the program 111. As a result, the control unit 140 achieves functions of a registration unit 141, an authentication control unit 142, and a processing unit 143.

The registration unit 141 receives a subscription registration request including a face image and information necessary for subscription registration from any user terminal 20, and performs registration processing thereof. Specifically, the registration unit 141 acquires a face image from the subscription registration request, and transmits a face feature information registration request including the acquired face image to the authentication apparatus 40. Then, the registration unit 141 receives the user ID issued at a time of registration of the face feature information from the authentication apparatus 40. Then, the registration unit 141 acquires necessary information from the subscription registration request, and registers the received user ID and the information in the information DB 112 in association with each other.

The authentication control unit 142 is equivalent to the acquisition unit 12 and the authentication processing unit 13 in FIG. 1. When an authentication request including a face image of a user is received from the store terminal 30, the authentication control unit 142 transmits an authentication request including the face image to the authentication apparatus 40. Then, the authentication control unit 142 receives a face authentication result from the authentication apparatus 40. When the face authentication is successful, the authentication control unit 142 specifies the subscription registration information associated with the collated face feature information.

The processing unit 143 is equivalent to the processing unit 14 in FIG. 1. The processing unit 143 transmits the specified subscription registration information to the store terminal 30. The store terminal 30 displays the specified subscription registration information as a result of authentication processing. Therefore, the processing unit 143 functions as a notification means for notifying a staff of a store of the result of the authentication processing. A staff of a store can confirm the subscription registration information displayed on a screen, and thereby perform provision of a product associated to the information.

Furthermore, when the payment information is registered in the information DB 112 in advance, the processing unit 143 can read the payment information associated with the user ID specified when the face authentication is successful, and transmit the read payment information to the store terminal 30. The store terminal 30 can perform the payment processing of a payment amount by using the payment information.

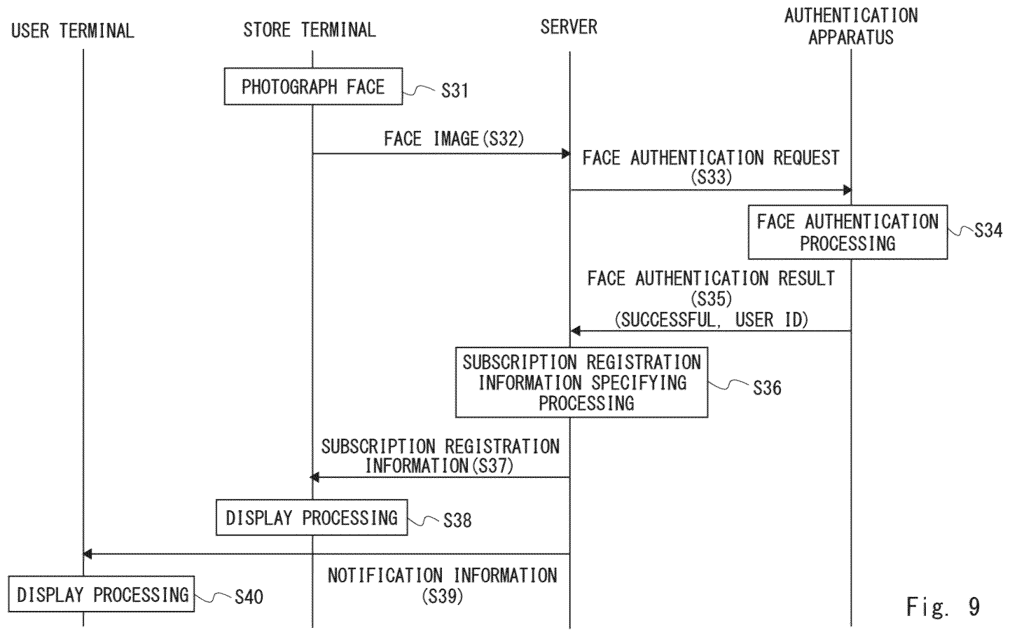

FIG. 9 is a sequence diagram illustrating a flow of provision of a service associated to the subscription registration information. First, the store terminal 30 photographs a face of a user with the camera 31 (S31). Then, the store terminal 30 outputs a face image to the server 10 (S32). The server 10 acquires the face image from the store terminal 30, and transmits a face authentication request including the acquired face image to the authentication apparatus 40 via the network N (S33). When receiving the face authentication request, the authentication apparatus 40 performs face authentication processing (S34).

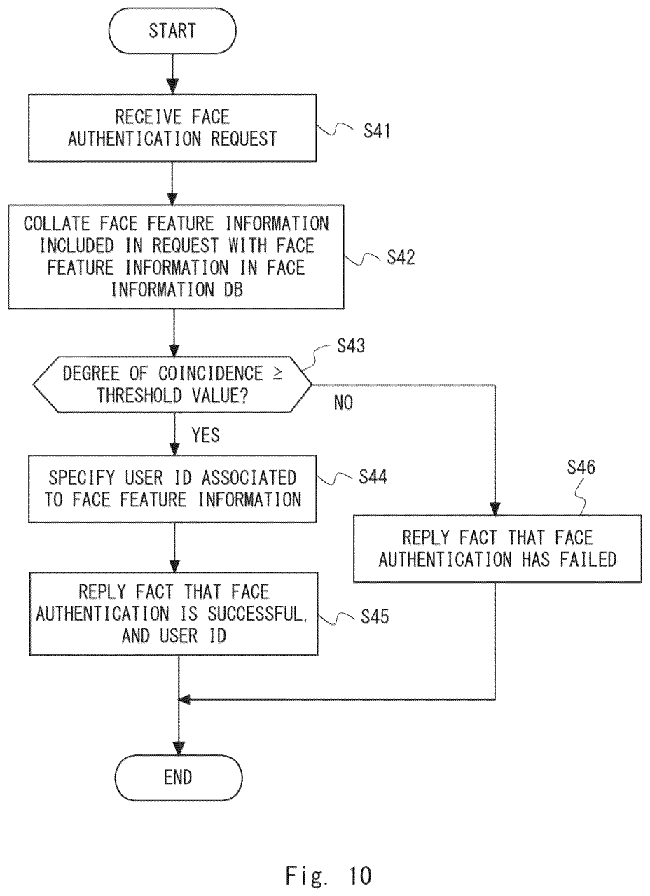

FIG. 10 is a flowchart illustrating a flow of the face authentication processing performed by the authentication apparatus 40. First, the authentication apparatus 40 receives a face authentication request from the server via the network N (S41). Note that, the authentication apparatus 40 may receive a face authentication request from the store terminal 30 or the like. Next, the authentication apparatus 40 extracts face feature information from a 10 face image included in the face authentication request. Then, the authentication unit 45 of the authentication apparatus 40 collates the face feature information extracted from the face image included in the face authentication request with face feature information in the face information DB 41 (S42), and calculates a degree of coincidence.

Then, the authentication unit 45 determines whether the degree of coincidence is equal to or greater than a threshold value (S43). When the face feature information matches, that is, when the degree of coincidence of the face feature information is equal to or greater than the threshold value, the authentication unit 45 specifies a user ID associated with the face feature information (S44). Then, the authentication unit 45 replies, to the server 10 via the network N, a face authentication result including a fact that the face authentication is successful and the specified user ID (S45). When the degree of coincidence is less than the threshold value in step S43, the authentication unit 45 replies, to the server 10 via the network N, a face authentication result including a fact that the face authentication has failed (S46).

Returning back to FIG. 9, the server 10 receives the face authentication result from the authentication apparatus 40 via the network N (S35). Then, the processing unit 143 of the server 10 executes processing of specifying the subscription registration information in response to the face authentication result (S36). When the face authentication is successful, the processing unit 143 reads the subscription registration information associated with the user ID included in the face authentication result from the information DB 112, and transmits the read subscription registration information to the store terminal 30 (S37). Thereafter, the store terminal 30 displays the received subscription registration information (S38).

Further, when the face authentication is successful, the processing unit 143 transmits the notification information related to the subscription registration information to the user terminal 20 (S39). When the notification information is a sales promotion content of the digital bingo game, the user terminal 20 displays the digital bingo card described above (S40). In other words, the processing unit 143 functions as an information provision means for performing provision of a sales promotion content used for sales promotion of a store.

The processing unit 143 can decide a frequency of opening the bingo, based on an amount of a registered subscription plan, a payment amount by face authentication other than the amount of the subscription plan, a usage history of a service, a visit history, and the like. The bingo card before the bingo is completed is stored in the information DB 112 of the server 10 in association with the user ID.

When the bingo is completed, the processing unit 143 can generate privilege information such as a coupon usable in a store for which subscription registration is performed or a nearby facility, and transmit the generated privilege information to the user terminal 20. Further, the sales promotion content may be privilege information used for sales promotion of a store being a destination of remitting a customer different from the store. Note that, the server 10 may transmit the notification information to the store terminal 30. Such privilege information such as the coupon may be associated with the user ID and stored in the information DB 112. A user can automatically receive application of the privilege information by performing face authentication at a time of the next visit.

When the face authentication has failed, the server 10 can transmit a fact that the authentication has failed to the store terminal 30. The store terminal 30 displays on a screen that confirmation of the subscription registration by the face authentication is not possible. Further, the store terminal 30 may notify the user terminal 20 of a fact that confirmation of the subscription registration by the face authentication is not possible by short-range wireless communication or the like. Note that, the face authentication request may be directly transmitted from the store terminal 30 to the authentication apparatus 40 without passing through the server 10, and the authentication apparatus 40 may transmit the face authentication result to the server 10.

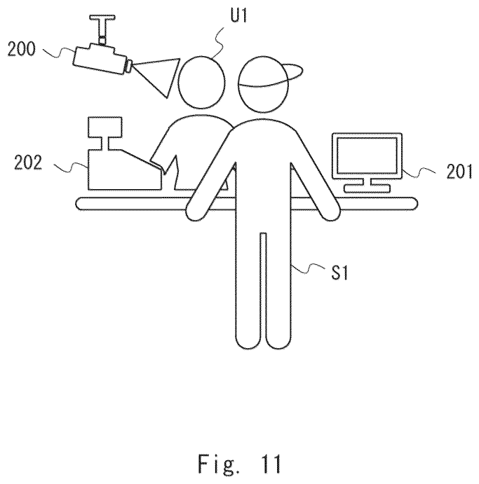

FIG. 11 is a diagram describing a flow at a time when a user receives provision of a service associated to subscription registration information. In the example illustrated in FIG. 11, a camera 200, a display apparatus 201, and a register apparatus 202 that are included in the store terminal 30 are separately provided. The display apparatus 201 is one example of the input/output unit 35 in FIG. 5, and the camera 200 is one example of the camera 31 in FIG. 5. The register apparatus 202 is equivalent to the above-described payment terminal. The register apparatus 202 and the display apparatus 201 are installed in a check-out counter where a staff S1 of a store is located. Further, the camera 200 is attached to an upper portion of the check-out counter.

When a first user U1 approaches the check-out counter, the camera 200 photographs the first user U1. The photographed image is transmitted to the server 10 as a face image for authentication. When the face authentication is successful, the server 10 specifies subscription registration information, and transmits the specified subscription registration information to the store terminal 30. The store terminal 30 displays the subscription registration information related to the authenticated user to be transmitted from the server 10.

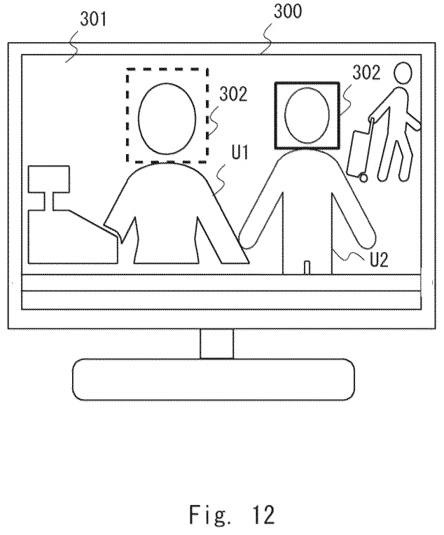

FIG. 12 is a diagram illustrating one example of a screen displayed on the display apparatus 201. On a screen 300, a photographed image 301 photographed by the camera 200 is displayed. It is assumed that the photographed image 301 includes an image of the first user U1 and a second user U2 located behind the first user U1. In the example illustrated in FIG. 12, a subscription registration information display 302 is superimposed and displayed on the photographed image 301.

In this example, the subscription registration information display 302 is a frame indicated by a broken line surrounding an image of a subscription service user. As described above, by superimposing and displaying the subscription registration information display 302 on the photographed image 301, the staff S1 can easily recognize whether the first user U1 is a user of a subscription service. Herein, it can be easily seen that both of the first user U1 and the second user U2 arranged behind the first user U1 are users of the subscription service.

Further, a color, a line type, and the like of the frame may be changed according to a type of a registered subscription plan. In the example illustrated in FIG. 12, it can be seen that the first user U1 surrounded by the frame with the broken line and the second user U2 surrounded by the frame with a solid line are different in subscription plan.

As described above, the staff S1 of a store can confirm a fact that the first user U1 is a user of a subscription service, a content of the subscription plan, and the like by confirming the screen 300, and perform provision of a product associated to the information.

As described above, according to the second example embodiment, a user can receive a service associated to subscription registration information without presenting a member card, only by performing face authentication with the store terminal 30 installed in a store. As a result, it is possible to improve efficiency of confirmation of subscription registration, and to achieve smooth provision of a service. Further, it is possible to prevent spoofing due to illegal acquisition of the member card, and it is possible to reduce loss of a business operator.

Further, manual confirmation of the member card becomes unnecessary, and effort and time of a staff of a store can be reduced. Furthermore, by providing a sales promotion content such as a digital bingo, and a coupon used for sales promotion of a store being a destination of remitting a customer different from a store performing subscription registration, it is possible to enclose a customer.

In the examples described above, a program includes instructions (or software code) that, when loaded into a computer, cause the computer to perform one or more of the functions described in the example embodiments. The program may be stored in a non-transitory computer-readable medium or a tangible storage medium. By way of example, and not limitation, the computer-readable medium or the tangible storage medium includes a random-access memory (RAM), a read-only memory (ROM), a flash memory, a solid-state drive (SSD), or other memory techniques, a CD-ROM, a digital versatile disc (DVD), a Blu-ray (registered trademark) disk, or other optical disk storages, or a magnetic cassette, a magnetic tape, a magnetic disk storage, or other magnetic storage devices. The program may be transmitted on a transitory computer-readable medium or a communication medium. By way of example, and not limitation, the transitory computer-readable medium or the communication medium includes a propagation signal in electrical, optical, acoustic, or other forms.

Note that, the present disclosure is not limited to the above-described example embodiment, and can be appropriately modified without departing from the spirit thereof. Further, the present disclosure may be implemented by appropriately combining each of the example embodiments.

Some or all of the above-described example embodiments may also be described as the following supplementary notes, but are not limited thereto.

### Supplementary Note A1

An information processing apparatus including:
a storage means for storing subscription registration information and biometric information of a user who receives provision of a service associated to the subscription registration information in association with each other; an acquisition means for acquiring biometric information of a user from a terminal installed in a store;
an authentication processing means for executing authentication processing of the acquired biometric information and the biometric information stored in the storage means; and
a processing means for outputting subscription registration information associated with biometric information of a user when the user is authenticated as a registrant by authentication processing of the authentication processing means.

### Supplementary Note A2

The information processing apparatus according to supplementary note A1, further including a notification means for notifying a staff of a store of a result of authentication processing by the authentication processing means.

### Supplementary Note A3

The information processing apparatus according to supplementary note A1 or A2, further including an information provision means for performing provision, to a user terminal of a user, of a sales promotion content used for sales promotion of the store, wherein
the sales promotion content is a bingo game using a digital bingo card in which a plurality of bingo frames are arranged, and
a frequency of opening a bingo frame is decided based on the subscription registration information in the digital bingo card.

### Supplementary Note A4

The information processing apparatus according to supplementary note A1 or A2, further including an information provision means for performing provision, to a user terminal of a user, of a sales promotion content used for sales promotion of a store being a destination of remitting a customer different from the store.

### Supplementary Note B1

An information processing system including:
a terminal installed in a store; and
an information processing apparatus, wherein
the information processing apparatus includes
a storage means for storing subscription registration information and biometric information of a user who receives provision of a service associated to the subscription registration information in association with each other,
an acquisition means for acquiring biometric information of a user from the terminal,
an authentication processing means for executing authentication processing of the acquired biometric information and the biometric information stored in the storage means, and
a processing means for outputting subscription registration information associated with biometric information of a user when the user is authenticated as a registrant by authentication processing of the authentication processing means.

### Supplementary Note B2

The information processing system according to supplementary note B1, wherein the information processing apparatus further includes a notification means for notifying a staff of a store of a result of authentication processing by the authentication processing means.

### Supplementary Note B3

The information processing system according to supplementary note B1 or B2, wherein
the information processing apparatus further includes an information provision means for performing provision, to a user terminal of a user, of a sales promotion content used for sales promotion of the store,
the sales promotion content is a bingo game using a digital bingo card in which a plurality of bingo frames are arranged, and
a frequency of opening a bingo frame is decided based on the subscription registration information in the digital bingo card.

### Supplementary Note B4

The information processing system according to supplementary note B1 or B2, wherein the information processing apparatus further includes an information provision means for performing provision, to a user terminal of a user, of a sales promotion content used for sales promotion of a store being a destination of remitting a customer different from the store.

### Supplementary Note C1

An information processing method including,
by a computer:
storing subscription registration information and biometric information of a user who receives provision of a service associated to the subscription registration information in association with each other;
acquiring biometric information of a user from a terminal installed in a store;
executing authentication processing of the acquired biometric information and the stored biometric information; and
outputting subscription registration information associated with biometric information of a user when the user is authenticated as a registrant by the authentication processing.

### Supplementary Note D1

A non-transitory computer-readable medium storing a program for causing a computer to execute:
processing of storing subscription registration information and biometric information of a user who receives provision of a service associated to the subscription registration information in association with each other;
processing of acquiring biometric information of a user from a terminal installed in a store;
processing of executing authentication processing of the acquired biometric information and the stored biometric information; and
processing of outputting subscription registration information associated with biometric information of a user when the user is authenticated as a registrant by the authentication processing.

Although the invention of the present application has been described with reference to the example embodiments (and examples), the invention of the present application is not limited to the above-described example embodiments (and examples). Various modifications that can be understood by a person skilled in the art within the scope of the invention of the present application can be made to the configuration and details of the invention of the present application.

### REFERENCE SIGNS LIST

1 INFORMATION PROCESSING APPARATUS
10 SERVER
11 STORAGE UNIT
12 ACQUISITION UNIT
13 AUTHENTICATION PROCESSING UNIT
14 PROCESSING UNIT
20 USER TERMINAL
21 CAMERA
22 STORAGE UNIT
23 MEMORY
24 COMMUNICATION UNIT
25 INPUT/OUTPUT UNIT
26 CONTROL UNIT
261 REGISTRATION UNIT
262 DISPLAY CONTROL UNIT
30 STORE TERMINAL
31 CAMERA
32 STORAGE UNIT
33 MEMORY
34 COMMUNICATION UNIT
35 INPUT/OUTPUT UNIT
36 CONTROL UNIT
361 DISPLAY CONTROL UNIT
362 AUTHENTICATION REQUEST UNIT
363 PAYMENT PROCESSING UNIT
40 AUTHENTICATION APPARATUS
41 FACE INFORMATION DB
42 FACE DETECTION UNIT
43 FEATURE POINT EXTRACTION UNIT
44 REGISTRATION UNIT
45 AUTHENTICATION UNIT
100 INFORMATION PROCESSING SYSTEM
110 STORAGE UNIT
111 PROGRAM
112 INFORMATION DB
120 MEMORY
130 COMMUNICATION UNIT
140 CONTROL UNIT
141 REGISTRATION UNIT
142 AUTHENTICATION CONTROL UNIT
143 PROCESSING UNIT
200 CAMERA
201 DISPLAY APPARATUS
202 REGISTER APPARATUS
300 SCREEN
301 PHOTOGRAPHED IMAGE
302 SUBSCRIPTION REGISTRATION INFORMATION DISPLAY
N NETWORK
S1 STAFF
U1 FIRST USER
U2 SECOND USER

What is claimed is:

1. An information processing apparatus comprising:
at least one memory storing instructions, and
at least one processor configured to execute the instructions to;
store subscription registration information and biometric information of a user who receives provision of a service associated to the subscription registration information in association with each other;
acquire biometric information of a user from a terminal installed in a store;
execute authentication processing of the acquired biometric information; and
output subscription registration information associated with biometric information of a user when the user is authenticated as a registrant by authentication processing.

2. The information processing apparatus according to claim 1, wherein at least one processor further configured to execute the instructions to notify a staff of a store of a result of authentication processing.

3. The information processing apparatus according to claim 1, wherein at least one processor further configured to execute the instructions to perform provision, to a user terminal of a user, of a sales promotion content used for sales promotion of the store, wherein
the sales promotion content is a bingo game using a digital bingo card in which a plurality of bingo frames are arranged, and
a frequency of opening a bingo frame is decided based on the subscription registration information in the digital bingo card.

4. The information processing apparatus according to claim 1, wherein at least one processor further configured to execute the instructions to perform provision, to a user terminal of a user, of a sales promotion content used for sales promotion of a store being a destination of remitting a customer different from the store.

5-8. (canceled)

9. An information processing method comprising,
by a computer:
storing subscription registration information and biometric information of a user who receives provision of a service associated to the subscription registration information in association with each other;
acquiring biometric information of a user from a terminal installed in a store;
executing authentication processing of the acquired biometric information and the stored biometric information; and
outputting subscription registration information associated with biometric information of a user when the user is authenticated as a registrant by the authentication processing.

10. A non-transitory computer-readable medium storing a program for causing a computer to execute:
processing of storing subscription registration information and biometric information of a user who receives provision of a service associated to the subscription registration information in association with each other;
processing of acquiring biometric information of a user from a terminal installed in a store;
processing of executing authentication processing of the acquired biometric information and the stored biometric information; and
processing of outputting subscription registration information associated with biometric information of a user when the user is authenticated as a registrant by the authentication processing.

11. The non-transitory computer-readable medium according to claim 10, wherein the program causes the compute to execute:
processing of notifying a staff of a store of a result of authentication processing.

12. The non-transitory computer-readable medium according to claim 10, wherein the program causes the compute to execute:
processing of performing provision, to a user terminal of a user, of a sales promotion content used for sales promotion of the store, wherein
the sales promotion content is a bingo game using a digital bingo card in which a plurality of bingo frames are arranged, and
a frequency of opening a bingo frame is decided based on the subscription registration information in the digital bingo card.

13. The non-transitory computer-readable medium according to claim 10, wherein the program causes the compute to execute:
processing of performing provision, to a user terminal of a user, of a sales promotion content used for sales promotion of a store being a destination of remitting a customer different from the store.
